(19) United States
(12) Patent Application Publication
(10) Pub. No.: US 2025/0174990 A1
(43) Pub. Date: May 29, 2025

(54) DC VOLTAGE ADAPTIVE COORDINATED CONTROL SYSTEM AND METHOD UNDER FAULT OF VSC-HVDC RECEIVING-END POWER GRID

(71) Applicant: Tianjin University, Tianjin (CN)

(72) Inventors: Jiebei Zhu, Tianjin (CN); Yi Hao, Tianjin (CN); Lujie Yu, Tianjin (CN); Fengdi Li, Tianjin (CN); Guoyan Wang, Tianjin (CN); Xiaolong Liu, Tianjin (CN)

(21) Appl. No.: 18/518,562

(22) Filed: Nov. 23, 2023

(51) Int. Cl. H02J 3/00; G05B 13/04; H02J 3/36

(52) U.S. Cl. CPC H02J 3/0012; G05B 13/042; H02J 3/36

(57) ABSTRACT

The present invention belongs to the field of smart grids, and relates to a DC voltage adaptive coordinated control system and method under fault of a VSC-HVDC receiving-end power grid. The present invention checks the MSR and compares it with the expected fastest fault clearance time to provide key activation conditions for the active power control of an SEC. When DC overvoltage is prevented, the active power regulation of the SEC and a dynamic brake resistor is reduced by optimizing the control activation thresholds and reference values of the SEC and a REC.

### TECHNICAL FIELD

The present invention belongs to the field of smart grids, and relates to a DC voltage adaptive coordinated control system and method under fault of a VSC-HVDC receiving-end power grid.

### BACKGROUND OF THE PRESENT INVENTION

As fossil fuel is gradually replaced by renewable energy, the commutation risk of line-commutated converter HVDC (LCC-HVDC) is rising. Voltage source converter HVDC (VSC-HVDC) which does not need to consider the strength requirements of a networking system is the best method to supply renewable energy power for the AC grid. Flexible power control and efficient VSC-HVDC operation are based on DC voltage safety. However, the active power of the receiving-end converter (REC) during fault of the receiving-end power grid is reduced, which causes power imbalance in the VSC-HVDC. The unbalanced power will be continuously stored in the DC capacitor as electric field energy, which prolongs the time of power imbalance and causes the DC voltage to gradually rise. Damage to the power semiconductor device and VSC-HVDC blocking which is possibly caused by DC overvoltage may compromise the stability of the power grids at a sending end and a receiving end. Therefore, it is important to provide a solution to ensure the safety of VSC-HVDC voltage under fault of the receiving-end power grid.

To reduce the influence of the fault of the receiving-end power grid, active power regulation or dynamic braking resistance of the sending-end converter (SEC) should be avoided or minimized. The accumulation of unbalanced power causes the change of dynamic characteristics of DC voltage. The safety margin of DC voltage is directly related to the time of power imbalance and the difference of active power between the SEC and the REC. The existing DC voltage control methods achieve instantaneous active power balance between the SEC and the REC by activating the active power regulation or dynamic braking resistance of the SEC at a predetermined threshold.

However, these methods may ignore the influence of the duration of the power imbalance on the safety margin of DC voltage, because the rising process is not considered and is independent of the reactive power control of the REC. Meanwhile, because it is difficult to effectively estimate the active power range of the SEC and the REC under the control of different reactive powers for the REC, the influence on the power grid at the sending end may be exacerbated and the redundancy of the active power regulation or dynamic braking resistance of the SEC may also be caused.

### SUMMARY OF PRESENT INVENTION

The purpose of the present invention is to provide a DC voltage adaptive coordinated control method under fault of a VSC-HVDC receiving-end power grid, so as to overcome the problem of VSC-HVDC blocking caused by the DC side overvoltage during the fault of the receiving-end power grid.

The present invention solves the technical problem through the following technical solution:

A DC voltage adaptive coordinated control system under fault of a VSC-HVDC receiving-end power grid comprises a main control circuit of VSC-HVDC, an adaptive coordinated control circuit of a sending-end converter (SEC) and an adaptive coordinated control circuit of a receiving-end converter (REC).

The main control circuit of the VSC-HVDC comprises a sending-end power grid, a sending-end AC line equivalent resistor, an SEC, a DC transmission line, a REC, a receiving-end AC line equivalent resistor and a receiving-end power grid.

The sending-end power grid sends AC to the SEC through the sending-end AC line equivalent resistor. Under the action of an adaptive coordinated control circuit of the SEC, the SEC converts AC into DC. DC is transmitted to the DC side of the REC through the DC transmission line. Under the action of the adaptive coordinated control circuit of the REC, the REC converts DC into AC and sends AC to the receiving-end power grid through the receiving-end AC line equivalent resistor.

Further, the sending-end power grid comprises two power generation sources: a new energy generator set and a synchronous motor set.

Further, the adaptive coordinated control circuit of the REC comprises an equivalent fault transitional resistance calculation module, a REC power reference value calculation module, using conditions of an adaptive coordinated control method and a double closed-loop controller of active power and reactive power of the REC.

Equivalent fault transitional resistance R_{f} is obtained by the equivalent fault transitional resistance calculation module from the active power P_{REC.0}, the reactive power Q_{REC.0} and the AC bus voltage amplitude U_{REC.0} of the REC.

The reference value p_{REC}^{ref} of active power and the reference value Q_{REC}^{ref} of reactive power are obtained by the REC power reference value calculation module from the equivalent fault transitional resistance R_{f}, the equivalent reactance X_{S} of the receiving-end power grid, the REC rated AC I_{REC.N}, maximum allowable AC coefficient K_{I} and the excitation reactance X_{T} of a coupling transformer.

The using conditions of the adaptive coordinated control method are used to judge whether a fault occurs in AC voltage of the receiving-end power grid and a set voltage threshold; and the reference values of the active power and the reactive power are generated when a fault occurs.

Further, the adaptive coordinated control circuit of the SEC comprises an SEC active power regulation coefficient calculation module, a power rebalancing duration calculation module corresponding to an SEC active power regulation coefficient K_{ref}, an SEC active power regulation coefficient calculation module, a maximum power imbalance duration calculation module, a power imbalance duration judgment module, an SEC active power calculation module, use conditions of the adaptive coordinated control method and an SEC-end active power controller.

A control reference value of the SEC active power regulation coefficient is obtained by the SEC active power regulation coefficient calculation module from a reference voltage value, a maximum allowable voltage coefficient, a DC line equivalent capacitance and a maximum allowable voltage coefficient generated at the REC side.

The power rebalancing duration corresponding to the SEC active power regulation coefficient is obtained by the power rebalancing duration calculation module corresponding to the SEC active power regulation coefficient from the control reference value of the SEC active power regulation coefficient, the SEC-side DC voltage, the maximum allowable voltage coefficient and the DC line equivalent capacitance.

A maximum power imbalance duration is obtained by the maximum power imbalance duration calculation module from the control reference value of the SEC active power regulation coefficient, the SEC-side DC voltage, the maximum allowable frequency of the sending-end power grid, the rated frequency of the sending-end power grid, SEC regulation time, the inertia constant of the sending-end AC power grid, and the proportion of new energy units.

The satisfactory maximum power imbalance duration is outputted by the power imbalance duration judgment module from the maximum power imbalance duration and expected fastest fault clearance time; and the SEC-end active power reference value is obtained by the SEC active power calculation module from the maximum power imbalance duration, and the power rebalancing duration corresponding to the SEC active power regulation coefficient K_{ref}.

The using conditions of the adaptive coordinated control method are used to judge whether a fault occurs in AC voltage of the sending-end power grid and the set voltage threshold; and the reference values of the active power is generated when a fault occurs.

A DC voltage adaptive coordinated control method under fault of a VSC-HVDC receiving-end power grid comprises the following steps:
S1: adaptive coordinated control of the REC;
S2: adaptive coordinated control of the SEC;
S3: the use conditions of adaptive coordinated control.

Further, the adaptive coordinated control method for the REC comprises the following steps:
S1.1: calculating equivalent fault transitional resistance;
S1.2: calculating the active and reactive power reference values of the REC through the calculated equivalent fault transitional resistance, and immediately changing the external loop control reference value of the REC to determine the minimum reactive power provided by the REC according to the safety and stability requirements of the receiving-end power grid;
S1.3: calculating the reference value of the SEC active power regulation coefficient by the determined minimum reactive power provided by the REC.

Further, a method for calculating the equivalent fault transitional resistance is as follows:

$$( 1 )$$

$${R}_{f} = [ \sqrt{{γ}^{2} - 4 {η ( {P}_{PEC \text{.0}} {X}_{T} {X}_{S} )}^{2} - 4 {η ( {U}_{REC \text{.0}}^{2} {X}_{s} + {Q}_{REC \text{.0}} {X}_{T} {X}_{S} )}^{2}} - γ ] / 2 η$$

wherein parameters η and γ are respectively:

$$\{ \begin{matrix}η = {( {U}_{REC \text{.0}}^{2} + {Q}_{REC \text{.0}} ( {X}_{S} + {X}_{T} ) )}^{2} + {( {P}_{REC \text{.0}} ( {X}_{S} + {X}_{T} ) )}^{2} - {U}_{REC \text{.0}}^{2} {E}_{S \text{.0}}^{2} \\ γ = 2 [ \begin{matrix}( {U}_{REC \text{.0}}^{2} {X}_{S} + {Q}_{REC \text{.0}} {X}_{T} {X}_{S} ) ( {P}_{REC \text{.0}} ( {X}_{S} + {X}_{T} ) ) \\ - ( {U}_{REC \text{.0}}^{2} + {Q}_{REC \text{.0}} ( {X}_{S} + {X}_{T} ) ) {P}_{REC \text{.0}} {X}_{T} {X}_{S}\end{matrix} ]\end{matrix} \qquad ( 2 )$$

wherein E_{S.0} represents the potential amplitude of the receiving-end power grid when a fault occurs, and is actually unchanged before and after the fault; U_{REC.0} represents the initial voltage of the REC before the fault; P_{REC.0} represents the initial active power of the REC before the fault; Q_{REC.0} represents the initial reactive power of the REC before the fault; X_{T} is the excitation reactance of a coupling transformer; and X_{S} is the equivalent reactance of the receiving-end power grid.

Further, the method for calculating the active and reactive power reference values of the REC through the calculated equivalent fault transitional resistance, and immediately changing the external loop control reference value of the REC to determine the minimum reactive power provided by the REC according to the safety and stability requirements of the receiving-end power grid is as follows:

$$\{ \begin{matrix}{P}_{REC}^{ref} = [ - A + \sqrt{{A}^{2} - 4 ( {( {Q}_{req}^{min} )}^{2} + {BQ}_{req}^{min} = C )} ] / 2 \\ {Q}_{REC}^{ref} = {Q}_{req}^{min}\end{matrix} \qquad ( 3 )$$

wherein parameters A, B and C are calculated according to the following equation:

$$\{ \begin{matrix}A = 2 \frac{{( 1.5 {K}_{I} {I}_{REC . N} )}^{2}}{( {R}_{f}^{2} + {X}_{S}^{2} )} {X}_{S}^{2} {R}_{f} \\ B = 2 \frac{{( 1.5 {K}_{I} {I}_{REC . N} )}^{2}}{( {R}_{f}^{2} + {X}_{S}^{2} )} ( {X}_{T} {X}_{S}^{2} + ( {X}_{T} + {X}_{S} ) {R}_{f}^{2} ) \\ C = {( 0.5 A )}^{2} + {( 0.5 B )}^{2} - \frac{{( 1.5 {K}_{I} {I}_{REC . N} )}^{2}}{( {R}_{f}^{2} + {X}_{S}^{2} )} {R}_{f}^{2} {E}_{S}^{2}\end{matrix}$$

wherein P_{REC}^{ref} is the active power reference value of the REC; Q_{REC}^{ref} is the reactive power reference value of the REC; Q_{req}^{min} is the minimum reactive power provided by the REC; I_{REC.N} is the rated AC of the REC; K_{I} is the maximum allowable AC coefficient; R_{f} is the equivalent resistance of the AC line of the receiving-end power grid; E_{S} is the equivalent voltage of the receiving-end power grid; X_{S} is the equivalent reactance of the receiving-end power grid; and A, B and C are intermediate variables in the calculation formula.

Further, the method for calculating the reference value of the SEC active power regulation coefficient by the determined minimum reactive power provided by the REC is as follows:

$${K}_{ref} = {( ( - {b}^{′} + \sqrt{{b}^{′2} - 4 {a}^{′} {c}^{′}} ) / 2 {a}^{′} )}^{2} \qquad ( 4 )$$

wherein parameters a′, b′ and c′ are calculated as follows:

$$\{ \begin{matrix}{a}^{′} = {C}_{eq} ( {K}_{U}^{2} - 1 ) {U}_{DC . SEC}^{2} \\ {b}^{′} = - 2 {P}_{SEC 0} \sqrt{{C}_{eq} ( {K}_{U}^{2} - 1 ) {U}_{DC . SEC}^{2}} \\ - A \sqrt{{C}_{eq} ( {K}_{U}^{2} - 1 ) {U}_{DC . SEC}^{2}} \\ {c}^{′} = C + {P}_{SEC 0}^{2} + {AP}_{SEC 0} + {( {Q}_{req}^{min} )}^{2} + {BQ}_{reg}^{min}\end{matrix} \qquad ( 5 )$$

wherein K_{U} is the maximum allowable voltage coefficient; U_{DC.SEC} is the DC voltage when the fault occurs at the sending end; C_{eq} is the equivalent capacitance of the DC line; K_{ref} is the reference value of the active power regulation coefficient; a′, b′ and c′ are the intermediate variables of the calculation formula; P_{SEC0} is the initial active power of the SEC before the fault; and Q_{req}^{min} is the minimum reactive power provided by the REC.

Further, the method for adaptive coordinated control of the SEC comprises the following steps:
S2.1: determining the active power of the SEC during the fault;
S2.2: calculating the value range of the coefficient K_{f} according to the determined active power of the SEC during the fault.

Further, the method for determining the active power of the SEC during the fault is: the unbalanced power on the DC side caused by the fault at the receiving-end power grid causes that the active power of the SEC and the active power of the REC are not equal. Due to the accumulation of the unbalanced power, it is equivalent to charging the VSC-HVDC DC-side capacitor. The DC voltage is increased steadily as the power imbalance time is increased. The active power of the SEC and the active power of the REC during the fault shall satisfy the following standard to prevent DC overvoltage from damaging the insulation of equipment or even blocking the VSC-HVDC:

$${\int }_{t}^{{t}_{e}} ( {P}_{SEC . f} - {P}_{REC . f} ) dt \leq 0.5 {C}_{eq} ( {K}_{U}^{2} - 1 ) {U}_{DC . N}^{2} \qquad ( 6 )$$

wherein P_{SEC.f} is the active power of the SEC; P_{REC.f} is the active power of the REC; C_{eq} is the equivalent capacitance of the DC line; K_{U} is the maximum allowable voltage coefficient; U_{DC.N} is the rated DC voltage; tₛ is the start time of the power imbalance of the SEC and the REC; and tₑ is the end time.

During the fault, the active power of the SEC is decreased linearly and coordinates with the active power of the REC to ensure the safety of the DC voltage. The active power of the SEC during the fault is expressed by the following formula:

$${P}_{SEC . f} = {P}_{SEC \text{.0}} - {K}_{f} t \qquad ( 7 )$$

wherein P_{SEC.0} is the initial active power of the SEC before the fault; K_{f} is the active power regulation coefficient of the SEC; when K_{f}=0, the active power of the SEC is unchanged as the initial active power; and when K_{f}≠0, the active power of the SEC may change with time. t is the system running time.

Further, the method for calculating the value range of the coefficient K_{f} according to the determined active power of the SEC during the fault is as follows:
when K_{f}=0, the active power of the SEC is unchanged as the initial active power; when K_{f}≠0, the active power of the SEC changes with time; t is the system running time; P_{SEC.f}: is the current active power of the SEC; P_{SEC.0} is the initial active power of the SEC before the fault; and the active power regulation coefficient and regulation time of the SEC satisfy the following conditions:

$${K}_{f} \leq \frac{( {f}_{max} - {f}_{0} )}{\begin{matrix}{R}_{G} [ \frac{( 1 + {T}_{G} {x}_{1} )}{{x}_{1}^{2} ( {x}_{1} - {x}_{2} )} {e}^{{x}_{1} {T}_{SEC}} + \frac{( 1 + {T}_{G} {x}_{2} )}{{x}_{2}^{2} ( {x}_{2} - {x}_{1} )} {e}^{{x}_{2} {T}_{SEC}} + \frac{1}{{x}_{1} {x}_{2}} {T}_{SEC} + \\ \frac{{x}_{1} + {x}_{2} + {T}_{G} {x}_{1} {x}_{2}}{{x}_{1}^{2} {x}_{2}^{2}} ]\end{matrix}} \qquad ( 8 )$$

wherein fₘₐₓ and f₀ are the maximum allowable frequency and rated frequency of the sending-end power grid respectively; T_{SEC} is the regulation time of the SEC; T_{G} is the equivalent time constant of a reheat turbine of a synchronous generator; K_{f} is the active power regulation coefficient of the SEC; and parameters x₁ and x₂ are given by the following formula:

$${x}_{1 , 2} = [ - b \pm \sqrt{{b}^{2} - 4 ac} ] / 2 a \qquad ( 9 )$$

wherein parameters a, b and c are:

$$\{ \begin{matrix}a = ( 2 {H}_{N} {φ}_{S} + 2 {H}_{S} - 2 {H}_{S} {φ}_{S} ) {R}_{G} {T}_{G} \\ b = ( 2 {H}_{N} {φ}_{S} + 2 {H}_{S} - 2 {H}_{S} {φ}_{S} ) {R}_{G} \\ + ( 1 - {φ}_{S} ) {F}_{G} {T}_{G} + ( {D}_{S} + {K}_{N} {φ}_{S} ) {R}_{G} {T}_{G} \\ c = ( 1 - {φ}_{S} ) + {R}_{G} ( {D}_{S} + {K}_{N} {φ}_{S} )\end{matrix} \qquad ( 10 )$$

H_{S}, D_{S} and Δf_{S} are the inertia constant, the proportion of the new energy generator set and the frequency change of the sending-end power grid respectively.

Further, the using conditions of the adaptive coordinated control method comprise the following steps:
S3.1: calculating the maximum power imbalance duration;
S3.2: determining the duration of SEC active power regulation and the initial activation time of a dynamic brake resistor;
S3.3: determining the using conditions of the adaptive coordinated control method by taking the three times obtained in steps S3.1 and S3.2 as judgment conditions.

Further, the method for calculating the maximum power imbalance duration is:

K_{f}=0 is assumed in formula (7), and combined with formulas (1), (2) and (9), the maximum reactive power that can be provided by the REC is sufficient to ensure the safety of DC voltage without controlling the active power of the SEC.

$${Q}_{REC}^{2} + {BQ}_{REC} + {( {P}_{SEC \text{.0}} - \frac{{C}_{eq} ( {K}_{U}^{2} - 1 ) {U}_{DC . N}^{2}}{2 T} )}^{2} + A ( {P}_{SEC \text{.0}} - \frac{{C}_{eq} ( {K}_{U}^{2} - 1 ) {U}_{DC . N}^{2}}{2 T} ) + C = 0 \qquad ( 11 )$$

The maximum reactive power in formula (17) is a quadratic function. The relationship between the solution of formula (17) and Q_{req}^{min} is compared to judge whether the maximum reactive power of the REC is greater than the minimum reactive power required by the sending-end power grid. Therefore, a quadratic formula is used to calculate the following content:

$$\frac{- B + \sqrt{\begin{matrix}{B}^{2} - 4 [ {( {P}_{SEC 0} - \frac{{C}_{eq} ( {K}_{U}^{2} - 1 ) {U}_{DC . N}^{2}}{2 T} )}^{2} + \\ A ( {P}_{SEC 0} - \frac{{C}_{eq} ( {K}_{U}^{2} - 1 ) {U}_{DC . N}^{2}}{2 T} ) + C ]\end{matrix}}}{2} \geq {Q}_{req}^{min} \qquad ( 12 )$$

Formula (19) is sorted to obtain an inequality about the power imbalance duration.

$${vT}^{2} + pT + q \leq 0 \qquad ( 13 )$$

wherein parameters v, p and q are:

$$\{ \begin{matrix}v = 4 {P}_{SEC 0}^{2} + 4 {AP}_{SEC 0} + 4 C + 4 {( {Q}_{req}^{min} )}^{2} + 4 {BQ}_{req}^{min} \\ p = - 4 {C}_{eq} ( {K}_{U}^{2} - 1 ) {U}_{DC . N}^{2} {P}_{SEC 0} - 2 {AC}_{eq} ( {K}_{U}^{2} - 1 ) {U}_{DC . N}^{2} \\ q = {( {C}_{eq} ( {K}_{U}^{2} - 1 ) {U}_{DC . N}^{2} )}^{2}\end{matrix} \qquad ( 14 )$$

Formula (19) is solved by the quadratic formula to obtain the maximum MSR of power imbalance duration:

$${T}_{MSR} = ( - p + \sqrt{{p}^{2} - 4 vq} ) / 2 v \qquad ( 15 )$$

T_{MSR} is the maximum power imbalance duration.

Further, the method for determining the duration of SEC active power regulation is:
the start time of SEC active power regulation is determined by the following formula:

$${T}_{SEC}^{s} = \{ \begin{matrix}{T}_{cut} , {T}_{MSR} > {T}_{cut} \\ {t}_{s} , {T}_{MSR} \leq {T}_{cut}\end{matrix} \qquad ( 16 )$$

wherein T_{cut} is the expected fastest fault clearance time, and T_{SEC}^{S} is the start time of SEC active power regulation.

The exit time of SEC active power regulation is

$${T}_{SEC}^{e} = {T}_{SEC}^{s} + min ( {T}_{reb}^{f} , {T}_{SEC}^{max} ) \qquad ( 17 )$$

wherein T_{SEC}^{max} represents the maximum allowable regulation time of the SEC; and t_{reb}^{f} represents the power rebalancing duration corresponding to the SEC active power regulation coefficient K_{ref}, calculated by the following formula:

$${T}_{reb}^{f} = \sqrt{{C}_{eq} ( {K}_{U}^{2} - 1 ) {U}_{DC . SEC}^{2} / {K}_{ref}} \qquad ( 18 )$$

If the time of the power balancing process exceeds the maximum allowable regulation time of the SEC, the active power regulation of the SEC is terminated after the maximum allowable regulation time of the SEC.

Further, the initial activation time of the dynamic brake resistor is obtained by the following formula to ensure the safety of the DC voltage.

The first activation time of the dynamic brake resistor is:

$${T}_{DBR} = \{ \begin{matrix}( {T}_{reb}^{f} - {T}_{SEC}^{max} ) / 2 , {T}_{reb}^{2} > {T}_{SEC}^{max} \\ LOCKing , {T}_{reb}^{f} < {T}_{SEC}^{max}\end{matrix} \qquad ( 19 )$$

Further, the method for determining the using conditions of the adaptive coordinated control method by taking the three times obtained in steps S3.1 and S3.2 as judgment conditions comprises:
if the time of the power balancing process is less than the maximum allowable regulation time of the SEC, not reducing the active power of the SEC when the DC voltage is accurately increased to the maximum allowable DC voltage and is not increased again in the power balancing process;
if the expected fastest fault clearance time is less than the maximum T_{MSR} of the power imbalance duration, maintaining the active power of the SEC as the initial active power temporarily;
if the expected fastest fault clearance time has passed and the AC bus voltage has not been restored, then adding the DC voltage at that time to formula (23) to calculate the active power regulation coefficient of the SEC, and reducing the active power of the SEC from that time;
when a smaller value of the power balancing duration and the maximum allowable regulation time of the SEC is reduced, resetting the active power regulation coefficient of the SEC to zero;
if the maximum allowable regulation time of the SEC is less than the time required for power balance, determining the initial activation time of the dynamic brake resistor according to formula (27);
after the fault is resolved, disabling the DC voltage adaptive coordinated control circuit to reduce AC overvoltage and DC voltage drop in the receiving-end power grid due to excessive reactive power and slow active power recovery.

The advantages and the beneficial effects of the present invention are as follows:

The DC voltage adaptive coordinated control system and method under fault of the VSC-HVDC receiving-end power grid considers the dynamic characteristics of the DC voltage, and describes the use ranges of the active power regulation coefficient of the SEC and the active power of the REC, so as to avoid DC overvoltage, called DC voltage safety domain (DVSD). The change of the power imbalance duration is studied to propose the maximum duration (MSR) of DC voltage safety and a calculation thought thereof when the REC active power is controlled only. Based on this, the present invention proposes the DC voltage adaptive coordinated control system and method under fault of the VSC-HVDC receiving-end power grid, which checks the MSR and compares it with the expected fastest fault clearance time to provide key activation conditions for the active power control of the SEC. When DC overvoltage is prevented, the active power regulation of the SEC and the dynamic brake resistor is reduced by optimizing the control activation thresholds and reference values of the SEC and the REC.

### DESCRIPTION OF THE DRAWINGS

FIG. 1 is an equivalent model of VSC-HVDC of the present invention;

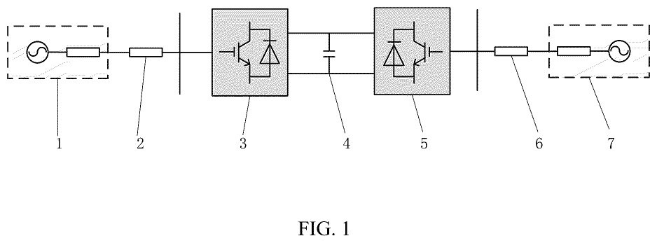

In the picture:

1—sending-end power grid; 2—sending-end AC line equivalent resistr; 3—sending-end converter (SEC); 4—DC transmission line; 5—receiving-end converter (REC); 6—receiving-end AC line equivalent resistor; 7—receiving-end power grid.

### DETAILED DESCRIPTION OF PREFERRED EMBODIMENTS

The present invention is further illustrated in tail below through specific embodiments. The following embodiments are only illustrative, not restrictive, and shall be not used for limiting the protection range of the present invention.

A DC voltage adaptive coordinated control system under fault of a VSC-HVDC receiving-end power grid comprises a main control circuit of VSC-HVDC, an adaptive coordinated control circuit of a sending-end converter (SEC) and an adaptive coordinated control circuit of a receiving-end converter (REC).

The main control circuit of the VSC-HVDC comprises a sending-end power grid 1, a sending-end AC line equivalent resistor 2, an SEC 3, a DC transmission line 4, a REC 5, a receiving-end AC line equivalent resistor 6 and a receiving-end power grid 7.

The sending-end power grid sends AC to the SEC through the sending-end AC line equivalent resistor. Under the action of an adaptive coordinated control circuit of the SEC, the SEC converts AC into DC. DC is transmitted to the DC side of the REC through the DC transmission line. Under the action of the adaptive coordinated control circuit of the REC, the REC converts DC into AC and sends AC to the receiving-end power grid through the receiving-end AC line equivalent resistor.

The sending-end power grid comprises two power generation sources: a new energy generator set and a synchronous motor set.

The adaptive coordinated control circuit of the REC comprises an equivalent fault transitional resistance calculation module, a REC power reference value calculation module, using conditions of an adaptive coordinated control method and a double closed-loop controller of active power and reactive power of the REC.

Equivalent fault transitional resistance R_{f} is obtained by the equivalent fault transitional resistance calculation module from the active power P_{REC.0}, the reactive power Q_{REC.0} and the AC bus voltage amplitude U_{REC.0} of the REC.

The reference value P_{REC}^{ref} of active power and the reference value Q_{REC}^{ref} of reactive power are obtained by the REC power reference value calculation module from the equivalent fault transitional resistance R_{f}, the equivalent reactance X_{S} of the receiving-end power grid, the REC rated AC I_{REC.N}, maximum allowable AC coefficient K_{I} and the excitation reactance X_{T} of a coupling transformer.

The using conditions of the adaptive coordinated control method are used to judge whether a fault occurs in AC voltage of the receiving-end power grid and a set voltage threshold; and the reference values of the active power and the reactive power are generated when a fault occurs.

The adaptive coordinated control circuit of the SEC comprises an SEC active power regulation coefficient calculation module, a power rebalancing duration calculation module corresponding to an SEC active power regulation coefficient K_{ref}, an SEC active power regulation coefficient calculation module, a maximum power imbalance duration calculation module, a power imbalance duration judgment module, an SEC active power calculation module, use conditions of the adaptive coordinated control method and an SEC-end active power controller.

A control reference value of the SEC active power regulation coefficient is obtained by the SEC active power regulation coefficient calculation module from a reference voltage value, a maximum allowable voltage coefficient, a DC line equivalent capacitance and a maximum allowable voltage coefficient generated at the REC side.

The power rebalancing duration corresponding to the SEC active power regulation coefficient is obtained by the power rebalancing duration calculation module corresponding to the SEC active power regulation coefficient from the control reference value of the SEC active power regulation coefficient, the SEC-side DC voltage, the maximum allowable voltage coefficient and the DC line equivalent capacitance.

A maximum power imbalance duration is obtained by the maximum power imbalance duration calculation module from the control reference value of the SEC active power regulation coefficient, the SEC-side DC voltage, the maximum allowable frequency of the sending-end power grid, the rated frequency of the sending-end power grid, SEC regulation time, the inertia constant of the sending-end AC power grid, and the proportion of new energy units.

The satisfactory maximum power imbalance duration is outputted by the power imbalance duration judgment module from the maximum power imbalance duration and expected fastest fault clearance time; and the SEC-end active power reference value is obtained by the SEC active power calculation module from the maximum power imbalance duration, and the power rebalancing duration corresponding to the SEC active power regulation coefficient K_{ref}.

The using conditions of the adaptive coordinated control method are used to judge whether a fault occurs in AC voltage of the sending-end power grid and the set voltage threshold; and the reference values of the active power is generated when a fault occurs.

The specific embodiment of the DC voltage adaptive coordinated control method under fault of the VSC-HVDC receiving-end power grid is as follows:

S1: calculating equivalent fault transitional resistance through the following formula.

$${R}_{f} = [ \sqrt{{γ}^{2} - 4 {η ( {P}_{REC \text{.0}} {X}_{T} {X}_{S} )}^{2} - 4 {η ( {U}_{REC \text{.0}}^{2} {X}_{s} + {Q}_{REC \text{.0}} {X}_{T} {X}_{S} )}^{2}} - γ ] / 2 η \qquad ( 20 )$$

wherein parameters η and γ are respectively:

$$\{ \begin{matrix}η = {( {U}_{REC \text{.0}}^{2} + {Q}_{REC \text{.0}} ( {X}_{S} + {X}_{T} ) )}^{2} + {( {P}_{REC \text{.0}} ( {X}_{S} + {X}_{T} ) )}^{2} - {U}_{REC \text{.0}}^{2} {E}_{S \text{.0}}^{2} \\ γ = 2 [ \begin{matrix}( {U}_{REC \text{.0}}^{2} {X}_{S} + {Q}_{REC \text{.0}} {X}_{T} {X}_{S} ) ( {P}_{REC \text{.0}} ( {X}_{S} + {X}_{T} ) ) \\ - ( {U}_{REC \text{.0}}^{2} + {Q}_{REC , 0} ( {X}_{S} + {X}_{T} ) ) {P}_{REC \text{.0}} {X}_{T} {X}_{S}\end{matrix} ]\end{matrix} \qquad ( 21 )$$

wherein E_{S.0} represents the potential amplitude of the receiving-end power grid when a fault occurs, and is actually unchanged before and after the fault; U_{REC.0} represents the initial voltage of the REC before the fault; P_{REC.0} represents the initial active power of the REC before the fault; Q_{REC.0} represents the initial reactive power of the REC before the fault; X_{T} is the excitation reactance of a coupling transformer; and X_{S} is the equivalent reactance of the receiving-end power grid.

S2: calculating the active and reactive power reference values of the REC by introducing the calculated equivalent fault transitional resistance into formula (3), and immediately changing the external loop control reference value of the REC to determine the minimum reactive power provided by the REC according to the safety and stability requirements of the receiving-end power grid.

$$\{ \begin{matrix}{P}_{REC}^{ref} = [ - A + \sqrt{{A}^{2} - 4 ( {( {Q}_{req}^{min} )}^{2} + {BQ}_{req}^{min} = C )} ] / 2 \\ {Q}_{REC}^{ref} = {Q}_{req}^{min}\end{matrix} \qquad ( 22 )$$

wherein parameters A, B and C are calculated according to the following equation:

$$\{ \begin{matrix}A = 2 \frac{{( 1.5 {K}_{I} {I}_{REC . N} )}^{2}}{( {R}_{f}^{2} + {X}_{S}^{2} )} {X}_{R}^{2} {R}_{f} \\ B = 2 \frac{{( 1.5 {K}_{I} {I}_{REC . N} )}^{2}}{( {R}_{f}^{2} + {X}_{S}^{2} )} ( {X}_{T} {X}_{S}^{2} + ( {X}_{T} + {X}_{S} ) {R}_{f}^{2} ) \\ C = {( 0.5 A )}^{2} + {( 0.5 B )}^{2} - \frac{{( 1.5 {K}_{I} {I}_{REC . N} )}^{2}}{( {R}_{f}^{2} + {X}_{S}^{2} )} {R}_{f}^{2} {E}_{S}^{2}\end{matrix}$$

wherein P_{REC}^{ref} is the active power reference value of the REC; Q_{REC}^{ref} is the reactive power reference value of the REC; Q_{req}^{min} is the minimum reactive power provided by the REC; I_{REC.N} is the rated AC of the REC; K_{I} is the maximum allowable AC coefficient; R_{f} is the equivalent resistance of the AC line of the receiving-end power grid; E_{S} is the equivalent voltage of the receiving-end power grid; X_{S} is the equivalent reactance of the receiving-end power grid; and A, B and C are intermediate variables in the calculation formula.

S3: calculating the reference value of the SEC active power regulation coefficient by the determined minimum reactive power provided by the REC.

$${K}_{ref} = ( {( - {b}^{'} + \sqrt{{b}^{' 2} - 4 {a}^{'} {c}^{'} )} / 2 {a}^{'} )}^{2} \qquad ( 23 )$$

wherein parameters a′, b′ and c′ are calculated as follows:

$$\{ \begin{matrix}{a}^{'} = {C}_{eq} ( {K}_{U}^{2} - I ) {U}_{DC . SEC}^{2} \\ {b}^{'} = - 2 {P}_{SEC 0} \sqrt{{C}_{eq} ( {K}_{U}^{2} - I ) {U}_{DC . SEC}^{2}} \\ - A \sqrt{{C}_{eq} ( {K}_{U}^{2} - I )} \\ {c}^{'} = C + {P}_{SEC 0}^{2} + {AP}_{SEC 0} + {( {Q}_{req}^{min} )}^{2} + {BQ}_{req}^{min}\end{matrix} \qquad ( 24 )$$

wherein K_{U} is the maximum allowable voltage coefficient; U_{DC.SEC} is the DC voltage when the fault occurs at the sending end; C_{eq} is the equivalent capacitance of the DC line; K_{ref} is the reference value of the active power regulation coefficient; a′, b′and c′ are the intermediate variables of the calculation formula; P_{SEC0} is the initial active power of the SEC before the fault; and Q_{req}^{min} is the minimum reactive power provided by the REC.

S4: determining the active power of the SEC during the fault. The unbalanced power on the DC side caused by the fault at the receiving-end power grid causes that the active power of the SEC and the active power of the REC are not equal. Due to the accumulation of the unbalanced power, it is equivalent to charging the VSC-HVDC DC-side capacitor. The DC voltage is increased steadily as the power imbalance time is increased. The active power of the SEC and the active power of the REC during the fault shall satisfy the following standard to prevent DC overvoltage from damaging the insulation of equipment or even blocking the VSC-HVDC:

$${\int }_{{t}_{s}}^{{t}_{e}} ( {P}_{SEC . f} - {P}_{REC . f} ) dt \leq 0.5 {C}_{eq} ( {K}_{U}^{2} - 1 ) {U}_{DC . N}^{2} \qquad ( 25 )$$

wherein P_{SEC.f} is the active power of the SEC; P_{REC.f} is the active power of the REC; C_{eq} is the equivalent capacitance of the DC line; K_{U} is the maximum allowable voltage coefficient; U_{DC.N} is the rated DC voltage; tₛ is the start time of the power imbalance of the SEC and the REC; and tₑ is the end time.

During the fault, the active power of the SEC is decreased linearly and coordinates with the active power of the REC to ensure the safety of the DC voltage. The active power of the SEC during the fault is expressed by the following formula:

$${P}_{SEC . f} = {P}_{SEC \text{.0}} - {K}_{f} t \qquad ( 26 )$$

wherein P_{SEC.0} is the initial active power of the SEC before the fault; K_{f} is the active power regulation coefficient of the SEC; when K_{f}=0, the active power of the SEC is unchanged as the initial active power; and when K_{f}≠0, the active power of the SEC may change with time. t is the system running time.

S5: determining the range of the coefficient K_{f} in formula (7) of step S4 through formula (8): when K_{f}=0, the active power of the SEC is unchanged as the initial active power; when K_{f}≠0, the active power of the SEC changes with time; t is the system running time; P_{SEC.f}: is the current active power of the SEC; P_{SEC.0} is the initial active power of the SEC before the fault; and the active power regulation coefficient and regulation time of the SEC satisfy the following conditions:

$${K}_{f} \leq \frac{( {f}_{max} - {f}_{0} )}{{R}_{G} [ \frac{( 1 + {T}_{G} {x}_{1} )}{{x}_{1}^{2} ( {x}_{1} - {x}_{2} )} {e}^{{x}_{1} {T}_{SEC}} + \frac{( 1 + {T}_{G} {x}_{2} )}{{x}_{2}^{2} ( {x}_{2} - {x}_{1} )} {e}^{{x}_{2} {T}_{SEC}} + \frac{1}{{x}_{1} {x}_{2}} {T}_{SEC} + \frac{{x}_{1} + {x}_{2} + {T}_{G} {x}_{1} {x}_{2}}{{x}_{1}^{2} {x}_{2}^{2}} ]} \qquad ( 27 )$$

wherein fₘₐₓ and f₀ are the maximum allowable frequency and rated frequency of the sending-end power grid respectively; T_{SEC} is the regulation time of the SEC; T_{G} is the equivalent time constant of a reheat turbine of a synchronous generator; K_{f} is the active power regulation coefficient of the SEC; and parameters x₁ and x₂ are given by the following formula:

$${x}_{1 , 2} = [ - b \pm \sqrt{{b}^{2} - 4 a c} ] / 2 a \qquad ( 28 )$$

wherein parameters a, b and c are:

$$\{ \begin{matrix}a = ( 2 {H}_{N} {φ}_{S} + 2 {H}_{S} - 2 {H}_{S} {φ}_{S} ) {R}_{G} {T}_{G} \\ \begin{matrix}b = ( 2 {H}_{N} {φ}_{S} + 2 {H}_{S} - 2 {H}_{S} {φ}_{S} ) {R}_{G} + \\ ( 1 - {φ}_{S} ) {F}_{G} {T}_{G} + ( {D}_{S} + {K}_{N} {φ}_{S} ) {R}_{G} {T}_{G}\end{matrix} \\ c = ( 1 - {φ}_{S} ) + {R}_{G} ( {D}_{S} + {K}_{N} {φ}_{S} )\end{matrix} \qquad ( 29 )$$

H_{S}, D_{S} and Δf_{S} are the inertia constant, the proportion of the new energy generator set and the frequency change of the sending-end power grid respectively.

S6: calculating the maximum power imbalance duration. K_{f}=0 is assumed in formula (7), and combined with formulas (1), (2) and (9), the maximum reactive power that can be provided by the REC is sufficient to ensure the safety of DC voltage without controlling the active power of the SEC.

$${Q}_{R E C}^{2} + B {Q}_{R E C} + {( {P}_{SEC \text{.0}} - \frac{{C}_{e q} ( {K}_{U}^{2} - 1 ) {U}_{D C . N}^{2}}{2 T} )}^{2} + A ( {P}_{SEC \text{.0}} - \frac{{C}_{e q} ( {K}_{U}^{2} - 1 ) {U}_{D C . N}^{2}}{2 T} ) + C = 0 \qquad ( 30 )$$

The maximum reactive power in formula (17) is a quadratic function. The relationship between the solution of formula (17) and Q_{req}^{min} is compared to judge whether the maximum reactive power of the REC is greater than the minimum reactive power required by the sending-end power grid. Therefore, a quadratic formula is used to calculate the following content:

$$\frac{- B + \sqrt{\begin{matrix}{B}^{2} - 4 [ {( {P}_{S E C 0} - \frac{{C}_{e q} ( {K}_{U}^{2} - 1 ) {U}_{DC . N}^{2}}{2 T} )}^{2} + \\ A ( {P}_{S E C 0} - \frac{{C}_{e q} ( {K}_{U}^{2} - 1 ) {U}_{DC . N}^{2}}{2 T} ) + C ]\end{matrix}}}{2} \geq {Q}_{req}^{min} \qquad ( 31 )$$

Formula (19) is sorted to obtain an inequality about the power imbalance duration.

$$v {T}^{2} + p T + q \leq 0 \qquad ( 32 )$$

wherein parameters v, p and q are:

$$\{ \begin{matrix}v = 4 {P}_{SEC \text{.0}}^{2} + 4 {AP}_{SEC 0} + 4 C + 4 {( {Q}_{req}^{min} )}^{2} + 4 {BQ}_{req}^{min} \\ p = - 4 {C}_{eq} ( {K}_{U}^{2} - 1 ) {U}_{D C . N}^{2} {P}_{SEC 0} - 2 A {C}_{eq} ( {K}_{U}^{2} - 1 ) {U}_{D C . N}^{2} \\ q = {( {C}_{eq} ( {K}_{U}^{2} - 1 ) {U}_{D C . N}^{2} )}^{2}\end{matrix} \qquad ( 33 )$$

Formula (19) is solved by the quadratic formula to obtain the maximum MSR of power imbalance duration:

$${T}_{M S R} = ( - p + \sqrt{{p}^{2} - 4 v q} ) / 2 v \qquad ( 34 )$$

T_{MSR} is the maximum power imbalance duration.

S7: determining the duration of SEC active power regulation. The start time of SEC active power regulation is determined by the following formula:

$${T}_{S E C}^{s} = \{ \begin{matrix}{T}_{cut} , {T}_{MSR} > {T}_{cut} \\ {t}_{s} , {T}_{MSR} \leq {T}_{cut}\end{matrix} \qquad ( 35 )$$

wherein T_{cut} is the expected fastest fault clearance time, and T_{SEC}^{S} is the start time of SEC active power regulation.

The exit time of SEC active power regulation is

$${T}_{S E C}^{e} = {T}_{S E C}^{s} + min ( {T}_{r e b}^{f} , {T}_{S E C}^{max} ) \qquad ( 36 )$$

wherein T_{SEC}^{max} represents the maximum allowable regulation time of the SEC; and T_{reb}^{f} represents the power rebalancing duration corresponding to the SEC active power regulation coefficient K_{ref}, calculated by the following formula:

$${T}_{r e b}^{f} = \sqrt{{C}_{e q} ( {K}_{U}^{2} - 1 ) {U}_{D C . SEC}^{2} / {K}_{r e f}} \qquad ( 37 )$$

S8: determining the using conditions of the adaptive coordinated control method.

If the time of the power balancing process exceeds the maximum allowable regulation time of the SEC, the active power regulation of the SEC is terminated after the maximum allowable regulation time of the SEC.

The initial activation time of the dynamic brake resistor is specified as follows, to ensure the safety of the DC voltage.

The first activation time of the dynamic brake resistor is:

$${T}_{DBR} = \{ \begin{matrix}( {T}_{reb}^{f} - {T}_{SEC}^{max} ) / 2 , {T}_{reb}^{2} > {T}_{SEC}^{max} \\ LOCKing , {T}_{reb}^{f} < {T}_{SEC}^{max}\end{matrix} \qquad ( 38 )$$

If the time of the power balancing process is less than the maximum allowable regulation time of the SEC, the active power of the SEC is not reduced when the DC voltage is accurately increased to the maximum allowable DC voltage and is not increased again in the power balancing process.

If the expected fastest fault clearance time is less than the maximum T_{MSR} of the power imbalance duration, the active power of the SEC is maintained as the initial active power temporarily.

If the expected fastest fault clearance time has passed and the AC bus voltage has not been restored, then the DC voltage at that time shall be added to formula (23) to calculate the active power regulation coefficient of the SEC, and the active power of the SEC is reduced from that time.

When a smaller value of the power balancing duration and the maximum allowable regulation time of the SEC is reduced, the active power regulation coefficient of the SEC is reset to zero.

If the maximum allowable regulation time of the SEC is less than the time required for power balance, the initial activation time of the dynamic brake resistor is determined according to formula (27).

After the fault is resolved, the DC voltage adaptive coordinated control circuit shall be disabled to reduce AC overvoltage and DC voltage drop in the receiving-end power grid due to excessive reactive power and slow active power recovery.

Although the embodiments and the drawings of the present invention are disclosed for the illustrative purpose, those skilled in the art may understand that various substitutions, variations and modifications without departing from the spirit and the scope of the present invention and the attached claims are possible, and thus the scope of the present invention is not limited to the disclosure of the embodiments and the drawings.

We claim:

1. A DC voltage adaptive coordinated control system under fault of a VSC-HVDC receiving-end power grid, comprising a main control circuit of VSC-HVDC, an adaptive coordinated control circuit of a sending-end converter (SEC) and an adaptive coordinated control circuit of a receiving-end converter (REC), wherein
the main control circuit of the VSC-HVDC comprises a sending-end power grid, a sending-end AC line equivalent resistor, an SEC, a DC transmission line, a REC, a receiving-end AC line equivalent resistor and a receiving-end power grid;
the sending-end power grid sends AC to the SEC through the sending-end AC line equivalent resistor; under the action of an adaptive coordinated control circuit of the SEC, the SEC converts AC into DC; DC is transmitted to the DC side of the REC through the DC transmission line; and under the action of the adaptive coordinated control circuit of the REC, the REC converts DC into AC and sends AC to the receiving-end power grid through the receiving-end AC line equivalent resistor.

2. The DC voltage adaptive coordinated control system under fault of the VSC-HVDC receiving-end power grid according to claim 1, wherein the adaptive coordinated control circuit of the REC comprises an equivalent fault transitional resistance calculation module, a REC power reference value calculation module, using conditions of an adaptive coordinated control method and a double closed-loop controller of active power and reactive power of the REC;
equivalent fault transitional resistance R_{f} is obtained by the equivalent fault transitional resistance calculation module from the active power P_{REC.0}, the reactive power Q_{REC.0} and the AC bus voltage amplitude U_{REC.0} of the REC;
the reference value P_{REC}^{ref} of active power and the reference value Q_{REC}^{ref} of reactive power are obtained by the REC power reference value calculation module from the equivalent fault transitional resistance R_{f}, the equivalent reactance X_{S} of the receiving-end power grid, the REC rated AC I_{REC.N}, maximum allowable AC coefficient K_{I} and the excitation reactance X_{T} of a coupling transformer;
the using conditions of the adaptive coordinated control method are used to judge whether a fault occurs in AC voltage of the receiving-end power grid and a set voltage threshold; and the reference values of the active power and the reactive power are generated when a fault occurs.

3. The DC voltage adaptive coordinated control system under fault of the VSC-HVDC receiving-end power grid according to claim 1, wherein the adaptive coordinated control circuit of the SEC comprises an SEC active power regulation coefficient calculation module, a power rebalancing duration calculation module corresponding to an SEC active power regulation coefficient K_{ref}, an SEC active power regulation coefficient calculation module, a maximum power imbalance duration calculation module, a power imbalance duration judgment module, an SEC active power calculation module, use conditions of the adaptive coordinated control method and an SEC-end active power controller;
a control reference value of the SEC active power regulation coefficient is obtained by the SEC active power regulation coefficient calculation module from a reference voltage value, a maximum allowable voltage coefficient, a DC line equivalent capacitance and a maximum allowable voltage coefficient generated at the REC side;
the power rebalancing duration corresponding to the SEC active power regulation coefficient is obtained by the power rebalancing duration calculation module corresponding to the SEC active power regulation coefficient from the control reference value of the SEC active power regulation coefficient, the SEC-side DC voltage, the maximum allowable voltage coefficient and the DC line equivalent capacitance;
a maximum power imbalance duration is obtained by the maximum power imbalance duration calculation module from the control reference value of the SEC active power regulation coefficient, the SEC-side DC voltage, the maximum allowable frequency of the sending-end power grid, the rated frequency of the sending-end power grid, SEC regulation time, the inertia constant of the sending-end AC power grid, and the proportion of new energy units;
the satisfactory maximum power imbalance duration is outputted by the power imbalance duration judgment module from the maximum power imbalance duration and expected fastest fault clearance time; and the SEC-end active power reference value is obtained by the SEC active power calculation module from the maximum power imbalance duration, and the power rebalancing duration corresponding to the SEC active power regulation coefficient K_{ref};
the using conditions of the adaptive coordinated control method are used to judge whether a fault occurs in AC voltage of the sending-end power grid and the set voltage threshold; and the reference values of the active power is generated when a fault occurs.

4. A DC voltage adaptive coordinated control method under fault of a VSC-HVDC receiving-end power grid, comprising the following steps:
S1: adaptive coordinated control of the REC;
S2: adaptive coordinated control of the SEC;
S3: the use conditions of adaptive coordinated control.

5. The DC voltage adaptive coordinated control method under fault of the VSC-HVDC receiving-end power grid according to claim 4, wherein the adaptive coordinated control method for the REC comprises the following steps:
S1.1: calculating equivalent fault transitional resistance;
S1.2: calculating the active and reactive power reference values of the REC through the calculated equivalent fault transitional resistance, and immediately changing the external loop control reference value of the REC to determine the minimum reactive power provided by the REC according to the safety and stability requirements of the receiving-end power grid;
S1.3: calculating the reference value of the SEC active power regulation coefficient by the determined minimum reactive power provided by the REC.

6. The DC voltage adaptive coordinated control method under fault of the VSC-HVDC receiving-end power grid according to claim 5, wherein a method for calculating the equivalent fault transitional resistance is as follows:
$${R}_{f} = [ \sqrt{\begin{matrix}{γ}^{2} - 4 {η ( {P}_{REC \text{.0}} {X}_{T} {X}_{S} )}^{2} - \\ 4 {η ( {U}_{REC \text{.0}}^{2} {X}_{s} + {Q}_{REC \text{.0}} {X}_{T} {X}_{S} )}^{2}\end{matrix}} - γ ] / 2 η \qquad ( 1 )$$
wherein parameters η and γ are respectively:
$$\{ \begin{matrix}η = {( {U}_{REC \text{.0}}^{2} + {Q}_{REC \text{.0}} ( {X}_{S} + {X}_{T} ) )}^{2} + {( {P}_{REC \text{.0}} ( {X}_{S} + {X}_{T} ) )}^{2} - {U}_{REC \text{.0}}^{2} {E}_{S \text{.0}}^{2} \\ γ = 2 [ \begin{matrix}[ ( {U}_{REC \text{.0}}^{2} {X}_{S} + {Q}_{REC \text{.0}} {X}_{T} {X}_{S} ) ( {P}_{REC \text{.0}} ( {X}_{S} + {X}_{T} ) ) - \\ ( {U}_{REC \text{.0}}^{2} + {Q}_{REC , 0} ( {X}_{S} + {X}_{T} ) ) {P}_{REC \text{.0}} {X}_{T} {X}_{S}\end{matrix} ]\end{matrix} \qquad ( 2 )$$
wherein E_{S.0} represents the potential amplitude of the receiving-end power grid when a fault occurs, and is actually unchanged before and after the fault; U_{REC.0} represents the initial voltage of the REC before the fault; P_{REC.0} represents the initial active power of the REC before the fault; Q_{REC.0} represents the initial reactive power of the REC before the fault; X_{T} is the excitation reactance of a coupling transformer; and X_{S} is the equivalent reactance of the receiving-end power grid.

7. The DC voltage adaptive coordinated control method under fault of the VSC-HVDC receiving-end power grid according to claim 5, wherein a method for calculating the active and reactive power reference values of the REC through the calculated equivalent fault transitional resistance, and immediately changing the external loop control reference value of the REC to determine the minimum reactive power provided by the REC according to the safety and stability requirements of the receiving-end power grid is as follows:
$$\{ \begin{matrix}{P}_{R E C}^{r e f} = [ - A + \sqrt{{A}^{2} - 4 ( {( {Q}_{r e q}^{min} )}^{2} + B {Q}_{r e q}^{min} = C )} ] / 2 \\ {Q}_{R E C}^{r e f} = {Q}_{r e q}^{min}\end{matrix} \qquad ( 3 )$$
wherein parameters A, B and C are calculated according to the following equation:
$$\{ \begin{matrix}A = 2 \frac{{( 1.5 {K}_{I} {I}_{REC . N} )}^{2}}{( {R}_{f}^{2} + {X}_{S}^{2} )} {X}_{S}^{2} {R}_{f} \\ B = 2 \frac{{( 1.5 {K}_{I} {I}_{REC . N} )}^{2}}{( {R}_{f}^{2} + {X}_{S}^{2} )} ( {X}_{T} {X}_{S}^{2} + ( {X}_{T} + {X}_{S} ) {R}_{f}^{2} ) \\ C = {( 0.5 A )}^{2} + {( 0.5 B )}^{2} - \frac{{( 1.5 {K}_{I} {I}_{REC . N} )}^{2}}{( {R}_{f}^{2} + {X}_{s}^{2} )} {R}_{f}^{2} {E}_{s}^{2}\end{matrix}$$
wherein P_{REC}^{ref} is the active power reference value of the REC; Q_{REC}^{ref} is the reactive power reference value of the REC; Q_{req}^{min} is the minimum reactive power provided by the REC; I_{REC.N} is the rated AC of the REC; K_{I} is the maximum allowable AC coefficient; R_{f} is the equivalent resistance of the AC line of the receiving-end power grid; E_{S} is the equivalent voltage of the receiving-end power grid; X_{S} is the equivalent reactance of the receiving-end power grid; and A, B and C are intermediate variables in the calculation formula.

8. The DC voltage adaptive coordinated control method under fault of the VSC-HVDC receiving-end power grid according to claim 5, wherein a method for calculating the reference value of the SEC active power regulation coefficient by the determined minimum reactive power provided by the REC is as follows:
$${K}_{ref} = {( ( - {b}^{′} + \sqrt{{b}^{′2} - 4 {a}^{′} {c}^{′}} ) / 2 {a}^{′} )}^{2} \qquad ( 4 )$$
wherein parameters a′, b′and c′ are calculated as follows:
$$\{ \begin{matrix}{a}^{′} = {C}_{eq} ( {K}_{U}^{2} - 1 ) {U}_{DC . SEC}^{2} \\ {b}^{′} = - 2 {P}_{SEC 0} \sqrt{{C}_{eq} ( {K}_{U}^{2} - 1 ) {U}_{DC . SEC}^{2}} \\ - A \sqrt{{C}_{eq} ( {K}_{U}^{2} - 1 ) {U}_{DC . SEC}^{2}} \\ {c}^{′} = C + {P}_{SEC 0}^{2} + {AP}_{SEC 0} + {( {Q}_{req}^{min} )}^{2} + {BQ}_{req}^{min}\end{matrix} \qquad ( 5 )$$
wherein K_{U} is the maximum allowable voltage coefficient; U_{DC.SEC} is the DC voltage when the fault occurs at the sending end; C_{eq} is the equivalent capacitance of the DC line; K_{ref} is the reference value of the active power regulation coefficient; a′, b′ and c′ are the intermediate variables of the calculation formula; P_{SEC0} is the initial active power of the SEC before the fault; and Q_{req}^{min} is the minimum reactive power provided by the REC.

9. The DC voltage adaptive coordinated control method under fault of the VSC-HVDC receiving-end power grid according to claim 4, wherein a method for adaptive coordinated control of the SEC comprises the following steps:
S2.1: determining the active power of the SEC during the fault;
S2.2: calculating the value range of the coefficient K_{f} according to the determined active power of the SEC during the fault.

10. The DC voltage adaptive coordinated control method under fault of the VSC-HVDC receiving-end power grid according to claim 9, wherein a method for determining the active power of the SEC during the fault is: determining by the following formula:
$${P}_{SEC . f} = {P}_{SEC \text{.0}} - {K}_{f} t \qquad ( 6 )$$
wherein P_{SEC.0} is the initial active power of the SEC before the fault; K_{f} is the active power regulation coefficient of the SEC; when K_{f}=0, the active power of the SEC is unchanged as the initial active power; and when K_{f}≠0, the active power of the SEC changes with time; and t is the system running time.

11. The DC voltage adaptive coordinated control method under fault of the VSC-HVDC receiving-end power grid according to claim 9, wherein a method for calculating the value range of the coefficient K_{f} according to the determined active power of the SEC during the fault is as follows:
when K_{f}=0, the active power of the SEC is unchanged as the initial active power; when K_{f}≠0, the active power of the SEC changes with time; t is the system running time; P_{SEC.f}: is the current active power of the SEC; P_{SEC.0} is the initial active power of the SEC before the fault; and the active power regulation coefficient and regulation time of the SEC satisfy the following conditions:
$${K}_{f} \leq \frac{( {f}_{max} - {f}_{0} )}{\begin{matrix}{R}_{G} [ \frac{( 1 + {T}_{G} {x}_{1} )}{{x}_{1}^{2} ( {x}_{1} - {x}_{2} )} {e}^{{x}_{1} {T}_{SEC}} + \frac{( 1 + {T}_{G} {x}_{2} )}{{x}_{2}^{2} ( {x}_{2} - {x}_{1} )} {e}^{{x}_{2} {T}_{SEC}} + \frac{1}{{x}_{1} {x}_{2}} {T}_{SEC} + \\ \frac{{x}_{1} + {x}_{2} + {T}_{G} {x}_{1} {x}_{2}}{{x}_{1}^{2} {x}_{2}^{2}} ]\end{matrix}} \qquad ( 7 )$$
wherein fₘₐₓ and f₀ are the maximum allowable frequency and rated frequency of the sending-end power grid respectively; T_{SEC} is the regulation time of the SEC; T_{G} is the equivalent time constant of a reheat turbine of a synchronous generator; K_{f} is the active power regulation coefficient of the SEC; and parameters x₁ and x₂ are given by the following formula:
$${x}_{1 , 2} = [ - b \pm \sqrt{{b}^{2} - 4 ac} ] / 2 a \qquad ( 8 )$$
wherein parameters a, b and c are:
$$\{ \begin{matrix}a = ( 2 {H}_{N} {φ}_{S} + 2 {H}_{S} - 2 {H}_{S} {φ}_{S} ) {R}_{G} {T}_{G} \\ b = ( 2 {H}_{N} {φ}_{S} + 2 {H}_{S} - 2 {H}_{S} {φ}_{S} ) {R}_{G} \\ + ( 1 - {φ}_{S} ) {F}_{G} {T}_{G} + ( {D}_{S} + {K}_{N} {φ}_{S} ) {R}_{G} {T}_{G} \\ c = ( 1 - {φ}_{S} ) + {R}_{G} ( {D}_{S} + {K}_{N} {φ}_{S} )\end{matrix} \qquad ( 9 )$$
H_{S}, D_{S} and Δf_{S} are the inertia constant, the proportion of the new energy generator set and the frequency change of the sending-end power grid respectively.

12. The DC voltage adaptive coordinated control method under fault of the VSC-HVDC receiving-end power grid according to claim 4, wherein the using conditions of the adaptive coordinated control method comprise the following steps:
S3.1: calculating the maximum power imbalance duration;
S3.2: determining the duration of SEC active power regulation and the initial activation time of a dynamic brake resistor;
S3.3: determining the using conditions of the adaptive coordinated control method by taking the three times obtained in steps S3.1 and S3.2 as judgment conditions.

13. The DC voltage adaptive coordinated control method under fault of the VSC-HVDC receiving-end power grid according to claim 12, wherein a method for calculating the maximum power imbalance duration is obtained by the following formula:
K_{f}=0 is assumed in formula (7), and combined with formulas (1), (2) and (9), the maximum reactive power that can be provided by the REC is sufficient to ensure the safety of DC voltage without controlling the active power of the SEC;
$${Q}_{REC}^{2} + {BQ}_{REC} + {( {P}_{SEC 0} - \frac{{C}_{eq} ( {K}_{U}^{2} - 1 ) {U}_{DC . N}^{2}}{2 T} )}^{2} + A ( {P}_{SEC \text{.0}} - \frac{{C}_{eq} ( {K}_{U}^{2} - 1 ) {U}_{DC . N}^{2}}{2 T} ) + C = 0 \qquad ( 10 )$$
the maximum reactive power in formula (17) is a quadratic function; the relationship between the solution of formula (17) and Q_{req}^{min} is compared to judge whether the maximum reactive power of the REC is greater than the minimum reactive power required by the sending-end power grid; therefore, a quadratic formula is used to calculate the following content:
$$\frac{\begin{matrix}- B + \sqrt{\begin{matrix}{B}^{2} - 4 [ {( {P}_{SEC 0} - \frac{{C}_{eq} ( {K}_{U}^{2} - 1 ) {U}_{DC . N}^{2}}{2 T} )}^{2} + \\ A ( {P}_{SEC 0} - \frac{{C}_{eq} ( {K}_{U}^{2} - 1 ) {U}_{DC . N}^{2}}{2 T} ) + C ]\end{matrix}}\end{matrix}}{2} \geq {Q}_{req}^{min} \qquad ( 11 )$$
formula (19) is sorted to obtain an inequality about the power imbalance duration;
$${vT}^{2} + pT + q \leq 0 \qquad ( 12 )$$
wherein parameters v, p and q are:
$$\{ \begin{matrix}v = 4 {P}_{SEC 0}^{2} + 4 {AP}_{SEC 0} + 4 C + 4 {( {Q}_{req}^{min} )}^{2} + 4 {BQ}_{req}^{min} \\ p = - 4 {C}_{eq} ( {K}_{U}^{2} - 1 ) {U}_{DC . N}^{2} {P}_{SEC 0} - 2 A {C}_{eq} ( {K}_{U}^{2} - 1 ) {U}_{DC . N}^{2} \\ q = {( {C}_{eq} ( {K}_{U}^{2} - 1 ) {U}_{DC . N}^{2} )}^{2}\end{matrix} \qquad ( 13 )$$
formula (19) is solved by the quadratic formula to obtain the maximum MSR of power imbalance duration:
$${T}_{MSR} = ( - p + \sqrt{{p}^{2} - 4 vq} ) / 2 v \qquad ( 14 )$$
T_{MSR} is the maximum power imbalance duration.

14. The DC voltage adaptive coordinated control method under fault of the VSC-HVDC receiving-end power grid according to claim 12, wherein a method for determining the duration of SEC active power regulation is:
the start time of SEC active power regulation is determined by the following formula:
$${T}_{SEC}^{s} = \{ \begin{matrix}{T}_{cut} , {T}_{MSR} > {T}_{cut} \\ {t}_{s} , {T}_{MSR} \leq {T}_{cut}\end{matrix} \qquad ( 15 )$$
wherein T_{cut} is the expected fastest fault clearance time, and T_{SEC}^{S} is the start time of SEC active power regulation;
the exit time of SEC active power regulation is
$${T}_{SEC}^{e} = {T}_{SEC}^{s} + min ( {T}_{reb}^{f} , {T}_{SEC}^{max} ) \qquad ( 16 )$$
wherein T_{SEC}^{max} represents the maximum allowable regulation time of the SEC; and T_{reb}^{f} represents the power rebalancing duration corresponding to the SEC active power regulation coefficient K_{ref}, calculated by the following formula:
$${T}_{reb}^{f} = \sqrt{{C}_{eq} ( {K}_{U}^{2} - 1 ) {U}_{DC . SEC}^{2} / {K}_{ref}} \qquad ( 17 )$$
if the time of the power balancing process exceeds the maximum allowable regulation time of the SEC, the active power regulation of the SEC is terminated after the maximum allowable regulation time of the SEC.

15. The DC voltage adaptive coordinated control method under fault of the VSC-HVDC receiving-end power grid according to claim 12, wherein the initial activation time of the dynamic brake resistor is obtained by the following formula:
$${T}_{DBR} = \{ \begin{matrix}( {T}_{reb}^{f} - {T}_{SEC}^{max} ) / 2 , {T}_{reb}^{2} > {T}_{SEC}^{max} \\ LOCKing , {T}_{reb}^{f} < {T}_{SEC}^{max}\end{matrix} . \qquad ( 18 )$$

16. The DC voltage adaptive coordinated control method under fault of the VSC-HVDC receiving-end power grid according to claim 12, wherein a method for determining the using conditions of the adaptive coordinated control method by taking the three times obtained in steps S3.1 and S3.2 as judgment conditions comprises:
if the time of the power balancing process is less than the maximum allowable regulation time of the SEC, not reducing the active power of the SEC when the DC voltage is accurately increased to the maximum allowable DC voltage and is not increased again in the power balancing process;
if the expected fastest fault clearance time is less than the maximum T_{MSR} of the power imbalance duration, maintaining the active power of the SEC as the initial active power temporarily;
if the expected fastest fault clearance time has passed and the AC bus voltage has not been restored, then adding the DC voltage at that time to formula (23) to calculate the active power regulation coefficient of the SEC, and reducing the active power of the SEC from that time;
when a smaller value of the power balancing duration and the maximum allowable regulation time of the SEC is reduced, resetting the active power regulation coefficient of the SEC to zero;
if the maximum allowable regulation time of the SEC is less than the time required for power balance, determining the initial activation time of the dynamic brake resistor according to formula (27);
after the fault is resolved, disabling the DC voltage adaptive coordinated control circuit to reduce AC overvoltage and DC voltage drop in the receiving-end power grid due to excessive reactive power and slow active power recovery.
